(19) United States
(12) Patent Application Publication
(10) Pub. No.: US 2018/0157457 A1
(43) Pub. Date: Jun. 7, 2018

(54) ENFORCING DISPLAY SHARING PROFILES ON A CLIENT DEVICE SHARING DISPLAY ACTIVITY WITH A DISPLAY SHARING APPLICATION

(71) Applicant: AIRWATCH LLC, Atlanta, GA (US)

(72) Inventors: NIRANJAN PARAMASHIVAIAH, Bangalore (IN); PAVAN RAJKUMAR RANGAIN, Bangalore (IN); MAHESH KAVATAGE, Bangalore (IN); SUMAN ALUVALA, Bangalore (IN)

(21) Appl. No.: 15/418,792

(22) Filed: Jan. 30, 2017

(30) Foreign Application Priority Data
Dec. 1, 2016 (IN) 201641041097

(51) Int. Cl. G06F 3/14; H04L 29/08; H04L 29/06

(52) U.S. Cl. CPC G06F 3/1454; H04L 67/306; H04L 65/1069; H04L 65/4069; H04L 65/4015

(57) ABSTRACT

Disclosed are various examples for facilitating sharing of activity on a display of a client device. The client device can be enrolled as a managed device with a management service. A display sharing profile can be created that specifies a whitelist and/or a blacklist of applications. Whitelisted applications are permitted to have activity occurring on the display shared with a display sharing applications. Blacklisted applications are not permitted to share activity with the display sharing application. The display sharing profile can be enforced by a management component or a display sharing application.

### RELATED APPLICATIONS

Benefit is claimed under 35 U.S.C. 119(a)-(d) to Foreign Application Serial No. 201641041097 filed in India entitled “ENFORCING DISPLAY SHARING PROFILES ON A CLIENT DEVICE SHARING DISPLAY ACTIVITY WITH A DISPLAY SHARING APPLICATION”, on Dec. 1, 2016, by AIRWATCH LLC., which is herein incorporated in its entirety by reference for all purposes.

### BACKGROUND

An enterprise can manage devices using a management service capable of protecting enterprise data including email and corporate documents, from theft, data loss, and unauthorized access. Enterprises might also provide the ability for users to request support from support personnel who can remotely administer users' devices. In some scenarios, support can be provided by establishing a display sharing session in which user interface activity within a particular application can be streamed to a management service or a remote support application. in some cases, an administrator or support personnel can assume control of the user's device to perform troubleshooting of a particular issue.

In some scenarios, such as a bring-your-own-device (BYOD) scenario, a user might not wish to have all of their application available to an administrator or support user who has assumed control of the user's device to provide support. For example, the user might want to maintain privacy of activity in a messaging application. As another example, the user might not wish to share or stream certain sensitive fields within an application, such as a password entry field, with a remote support user or administrator.

### BRIEF DESCRIPTION OF THE DRAWINGS

Many aspects of, the present disclosure can be better understood with reference to the following drawings. The components in the drawings are Trot necessarily to scale, with emphasis instead being placed upon dearly illustrating the principles of the disclosure. Moreover, in the drawings, like reference numerals designate corresponding parts throughout the several views.

FIG. 1 is a drawing of an example of a networked environment including a management system and at least one client device.

FIG. 2 is a drawing of an example of a networked environment including a management system, a display sharing system, and at least one client device.

FIG. 3 is a sequence diagram illustrating functionality implemented by components of the networked environment.

FIG. 4 is a sequence diagram illustrating functionality implemented by components of the networked environment.

FIGS. 5-6 are flowcharts illustrating functionality implemented by components of the networked environment.

### DETAILED DESCRIPTION

The present disclosure relates to sharing activity occurring on a display of a client device that is enrolled with a management service. User devices in an enterprise, such as smartphones or personal computers, can be enrolled with a management service as managed device. A management service can provide an administrator, such as one associated with an enterprise, with the ability to remotely manage the configuration of devices enrolled with the management service.

The management service can allow an administrator to define and install policies on enrolled devices. The management service can also provision enrolled devices with certain applications that are associated with the enterprise. Additionally, the management service can provide enrolled devices with access to enterprise data, such as documents, email, calendar data, or other enterprise information.

According to some examples described herein, a management service can receive a display buffer captured on the client device that shows user interface activity occurring on a managed device. The display buffer data can be obtained through one or more operating system application programming interfaces (APIs) that allow a management component installed on the client device to capture activity occurring on the display of the client device. The display buffer data can be provided to a display sharing application that can be executed on the client device or as a remotely executed service that is accessible to the client device over a network connection. In some examples, the display buffer data can be provided to the management service, which can have the functionality of the display sharing application integrated therein.

A display sharing profile can be installed by a management component on the client device. The display sharing profile can identify certain applications from which display buffer data can be shared to the display sharing applications. The management component or the display sharing application can enforce the policies specified by the display sharing profile. The display sharing profile can be obtained from the management service and updated as needed by the management service on the client devices that are enrolled as managed devices.

According to additional examples described herein, certain applications deployed by the management service can also specify a particular region of the display buffer or certain fields appearing within the application that should not be shared with the display sharing application and/or a remotely executed support application. For example, username/password fields or other portions of a user interface that might contain sensitive, information can be obscured or blocked from being shared with the display sharing application. This policy can be enforced by applications, the management component on the client device, or by the display sharing application.

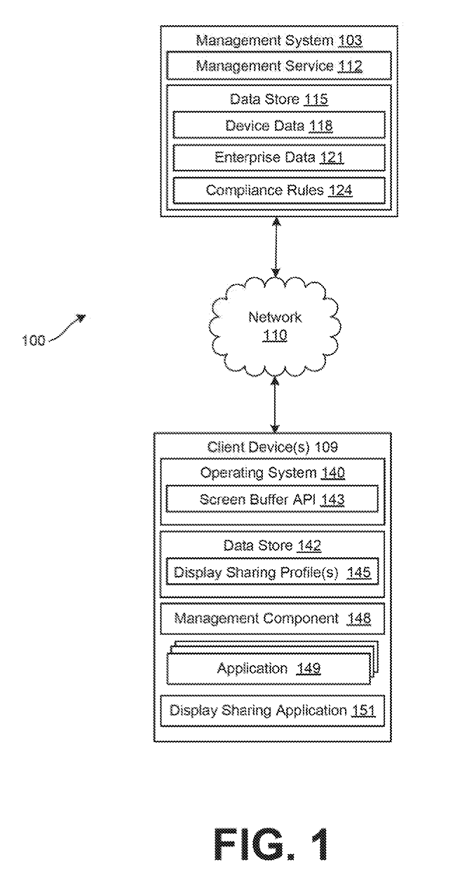

With reference to FIG. 1, shown is an example of a networked environment 100. The networked environment 100 can include a management system 103 and client device 109 in communication with one another over a network 110 The network 110 can include, for example, the Internet, intranets, extranets, wide area networks (WANs), local area networks (LANs), wired networks, wireless networks, other suitable networks, or any combination of two or more such networks. For example, the networks can include satellite networks, cable networks, Ethernet networks, telephony networks, and other types of networks.

The management system 103 can include, for example, a server computer or any other system providing computing capability. Alternatively, the management system 103 can include multiple computing devices that are arranged, for example, in one or more server banks, computer banks, or other arrangements. The management systems 103 can include a grid computing resource or any other distributed computing arrangement. The computing devices can be located in a single installation or can be distributed among many different geographical locations. The management systems 103 can also include or be operated as one or more virtualized computer instances. For purposes of convenience, the management system 103 is referred to herein in the singular. Even though the management system 103 is referred to in the singular, it is understood that multiple management systems 103 can be employed in the various arrangements as described above. As the management system 103 communicates with the client device 109 remotely over the network 110, the management system 103 can be described as a remote management system 103 or a collection of one or more remote computing devices.

The components executed on the management system 103 can include, for example, a management service 111 as well as other applications, services, processes, systems, engines, or functionality not discussed in detail herein. The management service 112 can oversee the operation of client devices 109 enrolled with the management service 112 as well as manage print operations performed by one or more client devices 109. In some embodiments, an enterprise, such as one or more companies or other organizations, can operate the management service 112 to oversee or manage the operation of the client devices 109 of its employees, contractors, customers, students, or other users having user accounts with the enterprise. An enterprise can be any customer of the management service 112.

The management service 112 can also provide the ability to an administrator to provide remote support to a client device 109 that is enrolled as a managed device. In one example, the management service 112 can create a user interface that allows an administrator to view what is being rendered on the display of a client device 109. The user interface can also allow the administrator to provide inputs, such as mouse movements, keystrokes, swipes, taps, or other inputs, that can be reflected on the user's device. In some examples of this disclosure, a user interface that can be used to provide remote support to a user can be implemented in a separate application from the management service 112.

The data store 115 can include memory of the management system 103, mass storage resources of the management system 103, or any other storage resources on which data can be stared by the management system 103. The data stored in the data store 115, for example, can be associated with the operation of the applications and/or functional entities described herein. The data stored in the data store 115 can include, for example, device data 118, enterprise data 121, compliance rules 124, as well as other data. Generally, device data 118 includes data associated with a configuration of a client device 109 enrolled or managed by the management service 112, For instance, the device data 118 can include an enrollment status indicating whether a client device 109 has been enrolled with the management service 112. In one example, a client device 109 designated as “enrolled” can be permitted to access the enterprise data 121 while a client device 109 designated as “not enrolled,” or having no designation, can be denied access to the enterprise data 121.

Additionally, device data 118 can include indications of the state of the client device 109. In one example, these indications can specify applications that are installed on the client device 109, configurations or settings that are applied to the client device 109, user accounts associated with the diem device 109, the physical location of the client device 109, the network to which the client device 109 is connected, and, other information describing the current state of the client device 109,

Further, device data 118 can also include data pertaining to user groups. An administrator can specify one or more of the client devices 109 as belonging to a particular user group. User groups can be created by an administrator of the management service 112 such that a batch of client devices 109 can be configured according to common settings. For instance, an enterprise can create a user group for the marketing department and the sales department, where the client devices 109 in the marketing department are configured differently from the client devices 109 in the sales department.

Device data 118 can further include a display sharing profile associated with a particular client device 109. A display sharing profile can identify applications for which a display sharing application is permitted receive, some or all of a display buffer when a respective application is foregrounded. For example, in a smartphone user interface or operating system a particular application can be foregrounded and consume most or all of the display on the device. In this sense, the display sharing profile can define an application whitelist.

The display sharing profile can also identify certain applications for which the display sharing application is not permitted to receive some or all of a display buffer when the application is foregrounded. In this sense, the display sharing profile can define an application blacklist.

The display sharing profile can identify applications by a bundle identifier, package family name, or any other identifier that uniquely identifies application with respect to other applications that can be installed on a client device 109. In some examples, the display sharing profile can specify a particular publisher by a publisher identifier on an application whitelist or blacklist. In this way, the display sharing profile can specify that all applications distributed by a particular publisher are associated with a whitelist or blacklist.

Compliance rules 124 can include, for example, configurable criteria that must be satisfied for an enrolled one of the client devices 109 to be “in compliance” with the management service 112. In one example, compliance rules 124 can include enterprise requirements that an enterprise requires to be completed on deployment or activation of the client devices 109, such as at the initial startup of the device, or upon a wipe or factory reset of the client device 109. The compliance rules 124 can also include an initial profile to send, enforce or enact on a client device 109 in response to an enrollment request for the client device 109 during its activation. The profile, enterprise requirements, and other compliance rules 124 can be based on a number of factors including geographical location of the client device 109, activation status, enrollment status, authentication data including authentication data obtained by a device registration system time, and date, and network properties, among other factors. The compliance rules 124 including the profile and the enterprise requirements can also be determined based on a user profile associated with a particular user or a device identifier of the client device 109. The user profile can be determined by obtaining authentication data from the client device 109. The user profile can be associated with compliance rules 124 that are further determined based on time, date, geographical location and network properties detected by the client device 109. The user profile can further be associated with a particular user group, and compliance rules 124 can be determined in view of the user group.

Compliance rules 124 can include predefined constraints that must be met in order for the management service 112, or other applications, to permit access to the enterprise data 121 or other features of the client device 109. In some examples, the management service 112 communicates with the management component 148 or other application 149 executable on the client device 109 to determine whether states exist on, the client device 109 that do not satisfy one or more compliance rules 124. Some of these states can include, for example, a virus or malware being detected on the client device 109; installation or execution of a blacklisted application 149; a client device 109 being “rooted” or “jailbroken,” where root access is provided to a user of the client device 109. Additional states can include the presence of particular files, questionable device configurations or vulnerable versions of applications 149, Another example of a compliance rule 124 can specify that the ability to obtain, or share the display buffer of a client device 109 should be disabled if screen capturing capabilities of the client device 109 are activated or enabled.

An enterprise, or an organization that provides computing resources, can execute the management service 112 within a computing environment operated by the enterprise or be a customer of another entity that operates the management service 112.

The client device 109 can be representative of one or more client devices 109. For purposes of convenience, the client device 109 is often referred to herein in the singular. The client device 109 can include a processor-based system, such as a computer system, that can include a desktop computer, a laptop computer, a personal digital assistant, a cellular telephone, a smartphone, a set-top box, a music player, a tablet computer system, a game console, an electronic book reader, a smartwatch, or any other device with like capability. The client device 109 can also be equipped with networking capability or networking interfaces, including a localized networking or communication capability, such as a near-field communication (NFC) capability, radio-frequency identification (RFID) read or write capability, or other localized communication capability.

The client device 109 can execute an operating system 140, a management component 148, one or more applications 149, and a display sharing application 151. The client device 109 can also include a data store 142, which can include a portion of mass storage, flash memory, or other storage resources of the client device 109.

The management component 148 can include a standalone application or a portion of the operating system 140. The management component 148 can be deployed by the management service 112 when the client device 109 is enrolled as a managed device with the management service 112. The operating system 140 can include application programming interfaces (APIs) that can allow the device to be enrolled with the management service 112 as a managed device and allow the management service 112 to deploy applications 149, configuration profiles, and management policies to the client device 109. The management component 148 can enforce policies and compliance rules 124, install profiles on the device, and otherwise oversee the operation of the client device 109 on behalf of the management service 112.

Applications 149 that can be installed on the client device 109 can include a browser, a device settings interface, or other applications. Further, other applications 149 can include device management applications, enterprise applications, social networking applications, word processors, spreadsheet applications, media player applications, or other applications. In some cases, the applications 149 are installed upon receiving a command from the management service 112 to retrieve and install the application 149 from an application repository or application marketplace.

The client devices 109 can include a display upon which a user interface is generated by an application 149. The display can be a liquid crystal display (LCD), organic light emitting. diode (OLED), touch-screen display, or other type of display device. The client device 109 can also include one or more input/output devices that can include, for example, a capacitive touchscreen or other type of touch input device, fingerprint reader, or keyboard.

Returning to the management component 148, once installed, the management service 112 can remotely configure the client device 109 by interacting with the management component 148 executed on the client device 109, for instance by causing the management component 148 to install a profile, execute a command, or render a user interface for display to a user. Further, the management service 112 can communicate various software components to the client device 109 that are then installed or configured by the management component 148 or at the direction of the management component 148 (e.g., by the operating system 140, at the direction of the management component 148). These software components can include, for example, applications 149, resources, libraries, drivers, device configurations, or other similar components that require installation on the client device 109 as specified by an administrator of the management service 112. The management service 112 can further cause policies to be enforced on the client device 109 by the management component 148 or by the operating system 140 of the client device 109. Policies can include, for example, restrictions or permissions pertaining to capabilities of a client device 109. For instance, policies can require certain hardware or software functions of the client device 109 to be enabled or be disabled during certain time period or when the client device 109 is physically located at a particular location.

The management service 112 can interact with one or more applications 149 executed on the client device 109 by transmitting data over the network 110. In one example, the management service 112 can interact with a management component 148 on the client device 109 to enroll the client device 109 with the management service 112. During the enrollment, the management component 148 can be registered as a device administrator of the client device 109, which can provide the management component 148 with sufficient privileges to control the operation of the client device 109. In one example, the management component 148 can be registered as the device administrator through the installation of a management profile in a profile bank of the operating system 140 of the client device 109 in response to a user of the client device 109 accepting terms and conditions related to management of the client device 109. The installation of the management profile in the profile bank of the operating system 140 causes the operating system 140 to designate the management component 148 as the device administrator, which allows the management component 148 or the management service 112 to instruct the operating system 140 to perform certain operations and configure the client device 109.

The management service 112 can instruct the management component 148 to perform device management functions on the diem device 109. For example, the management service 112 can direct the management component 148 to control access to certain software or hardware functions available on the client device 109. As a result, the management service 112 can verify that configuration and operation of the client device 109 is in conformance with predefined criteria that ensures that enterprise data or other data is protected from data loss, unauthorized access, or other harmful events. The management service 112 can, further provision enterprise data to the client device 109 through the management component 148.

In one example, the management service 112 can cause, the management component 148 to control use of the client device 109 or provision enterprise data to the client device 109 through use of a command queue provided by the management service 112. The management service 112 can store commands in a command queue associated with a particular client device 109 and can configure the management component 148 executed by the client device 109 to retrieve the contents of the command queue. In one example, the management component 148 can retrieve the contents of the command queue on a configured interval, such as every four hours, or upon occurrence of a certain event, such as a detection of an unauthorized application executed by the client device 109. In any case, the management component 148 can retrieve the contents of the command queue by checking in with the management service 112 and requesting the contents of the command queue, in one example, the contents of the command queue can include a command that the management component 148 causes to be executed on the client device 109. In another example, the contents of the command queue can include a resource or a application 149 that the management component 148 causes to be installed on the client device 109, which the client device 109 may access through a specified uniform resource locator (URL).

Also, the management service 112 can request that the client device 109 check-in using a notification service like APPLE® Push Notification Service (APNS), GOOGLE® Cloud Messaging (GCM), or WINDOWS® Push Notification Services (WNS). For example, the management service 112 can transmit a request to the notification service requesting that the client device 109 check-in. The notification service can push or otherwise route a notification to the client device 109. Once the notification is received, the operating system 140, management component 148, or another application 149 can cause the client device 109 to check-in with the management service 112.

Various compliance rules 12.4 can be enforced by the management service 112 on a client device 109 enrolled as a managed device. In one example, the command queue can be leveraged to enforce compliance rules 124 on an enrolled client device 109. Compliance rules 124 can be based on time, geographical location, or device and network properties. For instance, the client device 109 can satisfy a compliance rule 124 when the client device 109 is located within a particular geographic location. The client device 109 can satisfy a compliance rule 124 in other examples when the client device 109 is in communication with a particular local area network, such as a particular local area network that is managed by the computing environment 203. Furthermore, a compliance rule 124 in another example can be based upon the time and date matching specified values.

A compliance rale 124 can specify that a client device 109 is required to be off or in a low power “sleep” state during a specified time period. Another compliance rule 124 can specify that a client device 109 is required to be on or in a normal operation “awake” state during a specified time period. As another example, a compliance rule 124 can specify that a client device 109 is prohibited from rendering content that has been designated as confidential.

Other examples of compliance rules 124 include a rule that specifies whether a client device 109 is compromised or “jailbroken.” For example, a client device 109 can have hardware or software protections in place that prevent unauthorized modifications of the client device 109. if these protections are violated, overridden or bypassed, the client device 109 can be considered out of compliance. As another example, a compliance rule 124 can specify that the client device 109 is required to prompt a user for a password or personal identification number (PIN) in order to unlock the client device 109.

A compliance rule 124 can also require that the client device 109 have device encryption enabled, where data stored on the client device 109 is stored in an encrypted form. The data can be encrypted by a device certificate. A compliance rule 124 can also specify that the client device 109 is enrolled with the management service 112 as a managed device, causing the management service 112 to have device administrator privileges over the client device 109 to control and/or configure one or more functions of the client device 109 as described herein. Another compliance rule 124 can specify that the user is required to accept the terms of service that are presented by the management component 148 on the client device 109. As another example, a compliance rule 124 can specify that the management component 148 is required to periodically communicate or “check-in” with the management service 112 to report on its status. If a threshold amount of time has elapsed since the previous check-in, the client device 109 can be considered to have violated this compliance rule 124.

Another compliance rule 124 can specify that a client device 109 run one of a number of specified variants or versions of a particular operating system 140. A compliance rule 124 can also require that client devices 109 be manufactured by a particular manufacturer or that an enrolled client device 109 have a particular manufacturer identifier. Another compliance rule 124 can require that an enrolled device be a particular model name or model number. A client device 109 can also be considered out of compliance if the client device 109 is in a data, roaming mode or has used a threshold amount of a periodic network data usage allowance.

A compliance rule 124 can also identify a list of required applications that must be installed on the client device 109 (e.g., a whitelist) or a list of forbidden applications that are not allowed to be installed on the client device 109 (e.g., a blacklist). The management component 148 can remove a forbidden application or install a missing required, application on the client device 109 in response, to detecting a violation of such a compliance rule 124. A compliance ride 124 can also require the presence of a mobile device management (MDM) profile, an MDM storage area, an application profile, and/or a configuration profile. The management component 148 can obtain and store missing required data or containers on the client device 109 in response to detecting a violation of such a compliance rule 124.

The display sharing application 151 can be an application installed on the client device 109 for the purpose of capturing and/or sharing activity occurring on a display of the client device 109. In one example, the display sharing application 151 can share the activity occurring on the display with the management service 112 or another remotely executed service for the purpose of providing user support to a user of the client device 109. In another example, the display sharing application 151 can capture the activity occurring on the display for the purposes of a conference or presentation that is shared with other users on other devices over the network 110. In some examples, the display sharing application 151 can receive user inputs from a remote administrator that assumes control of the client device 109, and the user inputs can be reflected or performed on the client device 109 by the display sharing application 151.

The display sharing application 151 can capture activity occurring on the display of the client device 109 by obtaining an operating system display buffer from the operating system 140. The operating system display buffer can represent the contents of the display of the client device 109 and can be obtained by an application having sufficient privileges on the client device 109. Accordingly, the display sharing application 151 can installed with sufficient privileges or permissions to capture the operating system display buffer. In some instances, because the management component 148 is installed as the device administrator, the management component 148 can obtain the operating system display buffer on behalf of the display sharing application 151. In one example, the display sharing application 151 or management component 148 can obtain the contents of the operating system display buffer through a screen buffer API 143 provided by the operating system 140 on the client device 109. The operating system display buffer can then be streamed to the management service 112 or another remotely executed service.

One or more display sharing profiles 145 can be stored in the data store 142. A display sharing profile 145 can identify an application whitelist or blacklist of applications 149 for which the display sharing application 151 is permitted or restricted from obtaining the display buffer of the operating system 140. In one example, the when the display sharing application 151 is launched or requests the operating system display butler, the display sharing application 151 can transmit a request to the management component 148. The management component 148 can determine which application 149 is foregrounded and then determine whether the display sharing profile 145 identifies the application 149 as an application for which user interface activity can be shared through the display sharing application 151.

If the currently foregrounded application is identified by the display sharing profile 145 as a whitelisted application, the management component 148 can authorize the display sharing application 151 to obtain the display buffer or, stream the contents of the display buffer to the display sharing application 151. In some examples, the display sharing application 151 can directly consult the display sharing profile 145 and obtain the display buffer if the currently foregrounded application is a whitelisted application.

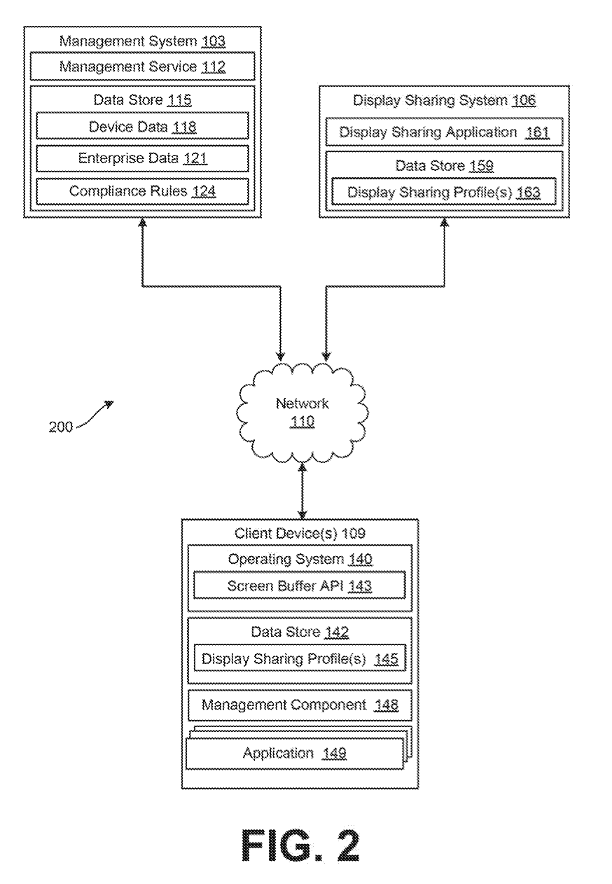

Turning now to FIG. 2, shown is an alternative networked environment 200 in which examples of the disclosure can be implemented. In FIG. 2, the display sharing application 151 is executed in a display sharing system 106 that is in coma cation with the client device 109 over a network. In this example, the display sharing system 106 executing the display sharing application 151 can be equipped with a data store 159 in which the display sharing profile 163 provisioned to the client device 109 can be stored or mirrored. In this scenario, upon launching of the display sharing application 151 by the user, the user can authenticate his or her identity using a federated authentication protocol that authenticates the user's identity using his or her enterprise credentials. Upon authentication of the user, the display sharing application 151 can obtain the display sharing profile 163 associated with the user from the management service 112. In some examples, the display sharing profile 145 on the client device 109 can mirror the display sharing profile 163 corresponding to the user on the display sharing system 106.

Additionally, in the scenario shown in FIG. 2, the display sharing application 151 can communicate with the operating system 140 or the management component 148 to obtain the display buffer when a whitelisted application 149 is foregrounded on the client device 109. Again, the management component 148 can enforce the display sharing profile 145 by determining that the currently foregrounded application 149 is a whitelisted application when the display sharing application 161 requests the display buffer.

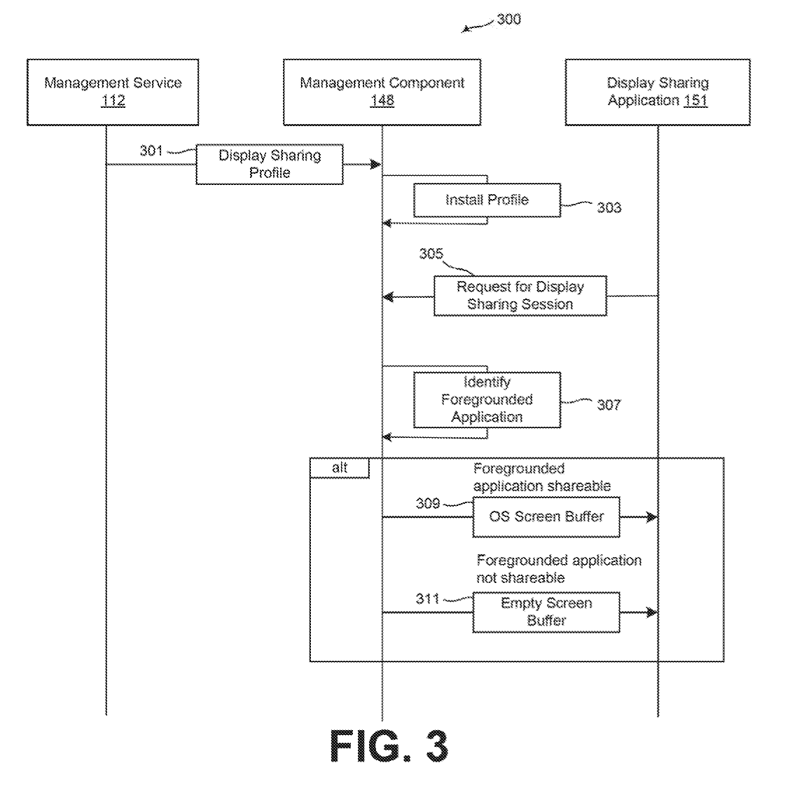

Turning now to FIG. 3, shown is a sequence diagram 300 illustrating various functionality of the components of the networked environment 100 or 200 to facilitate sharing of the display contents. Although the display sharing application 151 from the network environment 100 is depicted, the display sharing application 161 from the networked environment 200 can also be employed in the sequence diagram 300 of FIG. 3.

At step 301, the management service 112 can deploy a display sharing profile 145 to the client device 109. In the example of FIG. 3, the display sharing profile 145 can be provided by the management service 112 to the management component 148. In one scenario, the display sharing profile 145 can be provided, to the client device 109 in response to enrollment of the client device 109 as a managed device. In another scenario, the display sharing profile 145 can be provided to the client device 109 upon installation of the display sharing application 151. In one example, the management service 112 can initiate installation of the display sharing application 151 on the client device 109 along with the display sharing profile 145.

At step 303, the management component 148 can install the display sharing profile 145 on the client device 109. In one example, the display sharing profile 145 can be installed in an operating system profile storage area in the data store 142.

At step 305, the display sharing application 151 can transmit a request to initiate a display sharing session to the management component 148. In one scenario, the display sharing application 151 can be launched by the user, which can cause such a request to be transmitted to the management component 148. In another scenario, the management service 112 can communicate with the management component 148 to invoke the display sharing application 151, which can, also cause such a request to be generated.

At step 307, in response to receiving a request to initiate a display sharing session, the management component 148 can identify the currently foregrounded application 149 on the client device 109. The management component 148 can determine, the currently foregrounded application 149 by requesting a bundle identifier, package family name, or other identifying information of the currently foregrounded application 149 from the operating system 140.

Next, steps 309 and 311 present two alternative scenarios depending upon the currently foregrounded application. At step 309, if the currently foregrounded application 149 is identified by the display sharing profile 145 as one for which obtaining activity occurring on the display is permitted, the management component 148 can provide the operating system display buffer to the display sharing application 151 or authorize the display sharing application 151 to obtain it from the operating system 140. In one example, the management component 148 can obtain the operating, system display buffer from the display buffer API provided by the operating system 140 and stream it to the display sharing application 151. The display sharing application 151 can then provide the display buffer to the management service 112 or any other remotely executed application or service for various purposes.

At step 311, if the currently foregrounded application 149 is identified by the display sharing profile 145 as one for which obtaining activity occurring on the display is not permitted, the management component 148 can provide an empty screen buffer to the display sharing, application 151 or deny permission for the display sharing application 151 to obtain the display buffer from the operating system 140. For example, applications that might be blacklisted are banking applications, messaging applications, or any other applications in which sensitive or personal user information might appear within the display bullet in some examples, the user can be permitted to override the empty display buffer provided to the display sharing application 151 and provide the actual display buffer to the display sharing application 151.

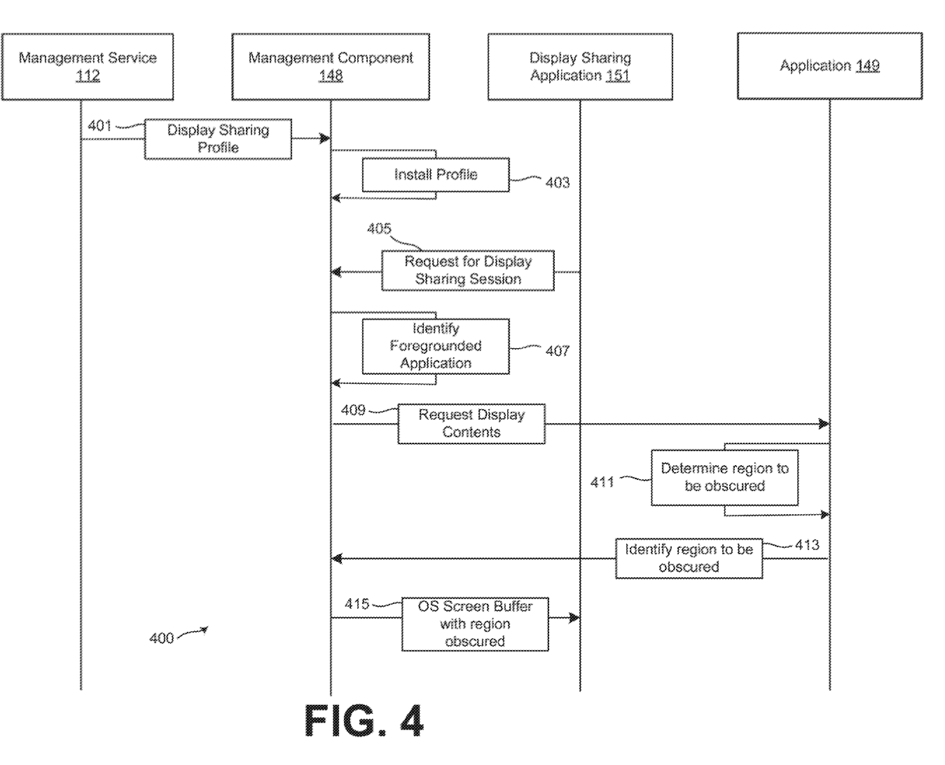

Turning now to FIG. 4, shown is a sequence diagram 400 illustrating various functionality of the components of the networked environment 100 or 200 to facilitate sharing of the display contents. Although the display sharing application 151 from the network environment 100 is depicted, the display sharing application 161 from the networked environment 200 can also be employed in the sequence diagram 300 of FIG. 4. FIG. 4 illustrates an example of how an application 149 can be instrumented to identify a region within the display buffer that should be obscured or hidden from the portion of the display buffer provided to the display sharing application 151.

At step 401, the, management service 112 can deploy a display sharing profile 145 to the client device 109. In the example of FIG. 4, the display sharing profile 145 can be provided by the management service 112 to the management component 148. In one scenario, the display sharing profile 145 can be provided to the client device 109 in response to enrollment of the client device 109 as a managed device. In another scenario, the display sharing profile 145 can be provided to the client device 109 upon installation of the display sharing application 151, in one example, the management service 112 can initiate installation of the display sharing application 151 on the client device 109 along with the display sharing profile 145.

At step 403, the management component 148 can install the display sharing profile 145 on the client device 109. In one example, the display sharing profile 145 can be installed in an operating system profile storage area in the data store 142.

At step 405, the display sharing application can transmit a request to initiate a display sharing session to the management component 148. In one scenario, the display sharing application 151 can be launched by the use which can cause such a request to be transmitted to the management component 148. In another scenario the management service 112 can communicate with the management component 148 to invoke the display sharing application 151, which can also cause such a request to be generated.

At step 407, in response to receiving a request to initiate a display sharing session, the management component 148 can identify the currently foregrounded application 149 on the client device 109. The management component 148 can determine the currently foregrounded application 149 by requesting a bundle identifier, package family name, other identifying information of the currently foregrounded application 149 from the operating system 140. The display sharing profile 145 can identify certain applications 14 as applications 149 that are configured to identify coordinates or regions of the display that should be obscured or hidden from the display sharing application 151. For example, certain regions of the display buffer can contain a username field, a password field, or other sensitive or private user information that should nit be shared with the display sharing application 151. When the management component 148 identifies such an application 149 as the current foregrounded application 149, the management component 148 can request from the application 149 which coordinates within the display buffer should be obscured or hidden.

At step 409, the management component 148 can request the display contents from the currently foregrounded application 149. In some examples, the request can take the form of a request for coordinates of one or more regions that should be obscured or hidden from the display buffer contents provided to the display sharing application 151.

At step 411, the application 149 can determine the region to be obscured or hidden. In one example, the application 149 can be instrumented to identify the coordinates of regions within the user interface of the application 149 that might contain sensitive or personal information of the user. In some examples, the application 149 can provide the coordinates to the management component 148 when certain fields appear within a user interface of the application 149 and notify the management component 148 when sensitive fields are no longer within the user interface of the application 149 so that the management component 148 can reveal or tin-obscure the region within the display buffer.

At step 413, the application 149 can identify the region to obscured to the management component 148. The region can be identified by coordinates within the display buffer that should be obscured.

At step 415, the management component 148 can provide the operating system display buffer to the display sharing application 151 or authorize the display sharing application 151 to obtain it from the operating system 140. In this example, the region identified by the application 149 can be obscured from the display buffer provided to the display sharing application 151. In one example, the management component 148 can obtain the operating system display buffer from the display buffer API provided by the operating system 140 and stream it to the display sharing application 151 with the region obscured or hidden. The display sharing application 151 can then provide the display buffer to the management service 112 or any other remotely executed application or service for various purposes.

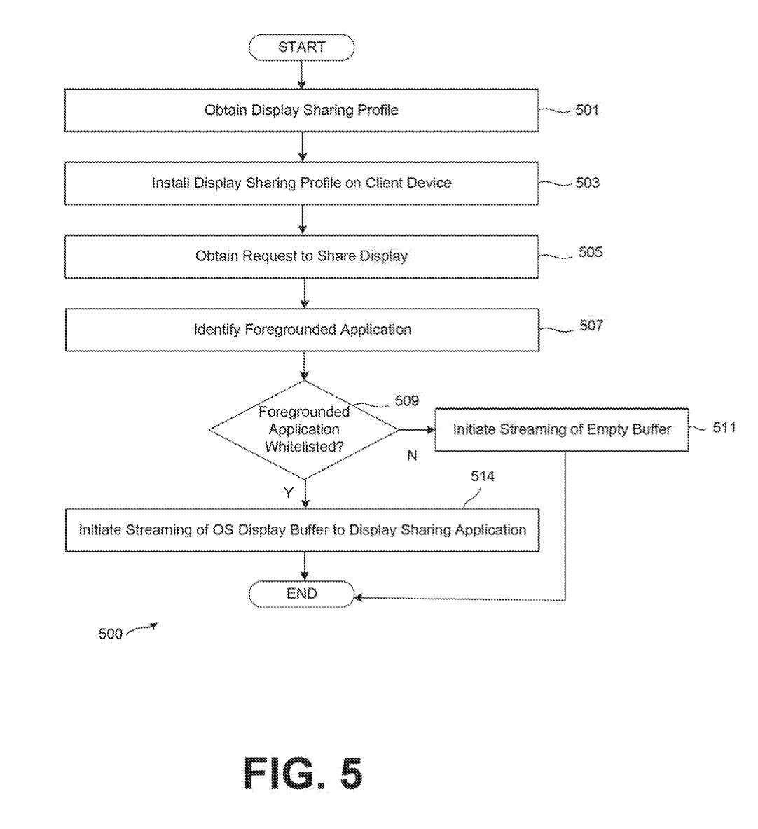

With reference to FIG. 5, shown is a flowchart 500 illustrating functionality implemented by the client device 109. Starting with step 501, the client device 109 can obtain a display sharing profile 145 that corresponds to the client device 109. As noted above, the display sharing profile can be obtained from the management service 112 by the management component 148.

Moving to, step 503, the management component 148 can install the display sharing profile 145 on the client device 109 by saving the profile within the data store 142. The display sharing profile 145 can be made accessible to the display sharing application 151 installed on, the client device 109 and/or to an instance of a display sharing application 161 implemented as a web-based application on a display sharing system 106.

At step 505, the client device 109 can obtain a request to share its display. The request can be received from the management service 112 or any other remotely executed service. In some examples, the request can be received from the display sharing application 151 executed on the client device 109 or in a display sharing system 106.

At step 507, the client device 109 can identify the foregrounded application 149 on the client device 109. The currently foregrounded application 149 can be identified by the management component 148 using an operating system API call that identifies the currently foregrounded application 149 by a bundle identifier, a publisher identifier, package family name, or any other identifier that allows the application to be uniquely identified with respect to other applications 149.

At step 509, the client device 109 can determine whether the currently foregrounded application 149 is a whitelisted application. In other words, the client device 109 can determine whether the currently foregrounded application 149 is identified by the display sharing profile as an application that the display sharing application 151 is permitted to obtain or stream the display buffer during execution. In some examples, the display sharing application 151 can identify a publisher or developer identifier so that all application published by a particular developer can be whitelisted or blacklisted.

If, at step 509, the currently foregrounded application 149 is, not a whitelisted application 149, the process proceeds to step 511. At step 511, the client device 109 can initiate streaming of an empty display buffer, or a display buffer that does not include the contents of the display of the client device 109. In some examples, the client device 109 can terminate streaming of the operating system display buffer or produce a stream with a message that indicates to a viewer that the client device 109 currently has a non-whitelisted application foregrounded, in one example, the management component 148 can stream the empty display buffer to the display sharing application 151, which can in turn stream the empty display buffer to the management service 112 or another remotely executed service. In another example, the display sharing application 151 executing on the client device 109 can stream the empty display buffer to a remotely executed service without first obtaining the empty display buffer from the management component 148. In a scenario in which the display sharing application 161 is executed in a display sharing system 106, the management component 148, the operating system 140, or another component installed on the client device 109, such as a browser plug-in, can stream the empty display buffer to the display sharing application 161. Thereafter, the process shown in FIG. 5 proceeds to completion

If, at step 509, the currently foregrounded application 149 is a whitelisted application, the process can proceed to step 514. At step 514, the client device 109 can initiate streaming of the operating system display buffer to the display sharing application 151. In one example, the management component 148 can stream the operating system display buffer to the display sharing application 151, which can in turn stream the operating system display buffer to the management service 112 or another remotely executed service. In another example, the display sharing application 151 executing on the client device 109 can stream the operating system display buffer to a remotely executed service without first obtaining the operating system display buffer from the management component 143. In a scenario in which the display sharing application 161 is executed in a display sharing system 106, the management component 148, the operating system 140, or another component installed on the client device 109, such as a browser plug-in, can stream the operating system display buffer to the display sharing application 161, Thereafter, the process shown in FIG. 5 proceeds to completion.

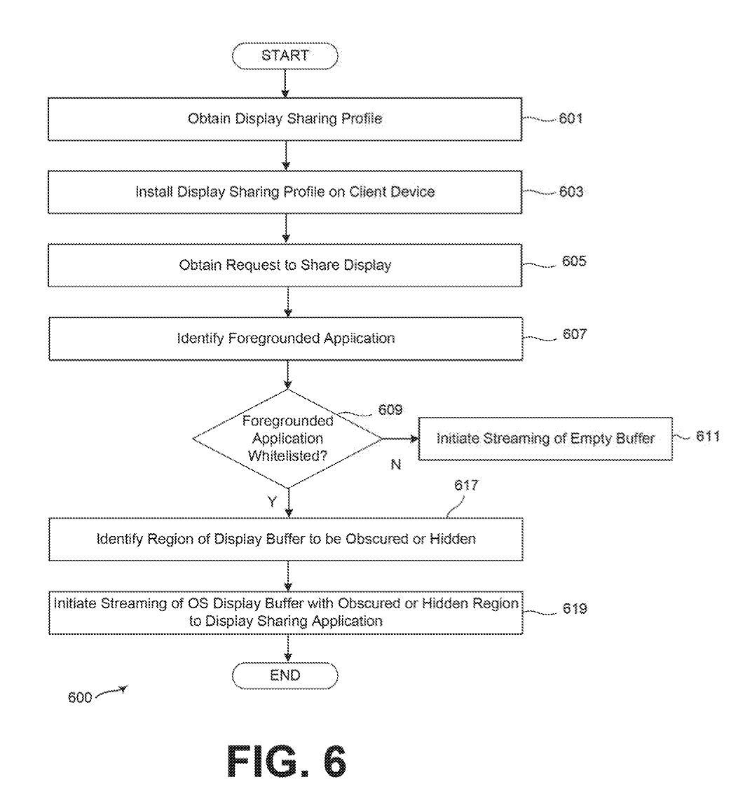

With reference to FIG. 6, shown is a flowchart 600 illustrating functionality implemented by the client device 109. FIG. 6 illustrates how the client device 109 can stream an operating system display buffer fora whitelisted application 149 with a particular region of the display buffer obscured or hidden. Starting with step 601, the client device 109 can obtain a display sharing profile 145 that corresponds to the client device 109. As noted above, the display sharing profile can be obtained from the management service 112 by the management component 148.

Moving to step 603, the management component 148 can install the display sharing profile 145 on the client device 109 by saving the profile within the data store 142. The display sharing profile 145 can be made accessible to the display sharing application 151 installed on the client device 109 and/or to an instance of a display sharing application 161 implemented as a web-based application on a display sharing system 106.

At step 605, the client device 109 can obtain a request to share its display. The request can be received from the management service 112 or any other remotely executed service. In some examples, the request can be received from the display sharing application 151 executed on the client device 109 or in a display sharing system 106.

At step 607, the client device 109 can identify the foregrounded application 149 on the client device 109. The currently foregrounded application 149 can be identified by the management component 148 using an operating system API call that identifies the currently foregrounded application 149 by a bundle identifier, a publisher identifier, package family name, or any other identifier that allows the application to be uniquely identified with respect to other applications 149.

At step 609, the client device 109 can determine whether the currently foregrounded application 149 is a whitelisted application. In other words, the client device 109 can determine whether the currently foregrounded application 149 is identified by the display sharing profile as an application that the display sharing, application 151 is permitted to obtain or stream the display buffer during execution. In some examples, the display sharing application 151 can identify a publisher or developer identifier so that all application published by a particular developer can be whitelisted or blacklisted.

If, at step 609, the currently foregrounded application 149 is not a whitelisted application 149, the process proceeds to step 611. At step 611, the client device 109 can initiate streaming of an empty display buffer, or a display buffer that does not include the contents of the display of the client device 109. In some examples, the client device 109 can terminate streaming of the operating system display buffer or produce a stream with a message that indicates to a viewer that the client device 109 currently has a non-whitelisted application foregrounded. In one example, the management component 148 can stream the empty display buffer to the display sharing application 151, which can in turn stream the empty display buffer to the management service 112 or another remotely executed service. In another example, the display sharing application 151 executing on the client device 109 can stream the empty display buffer to a remotely executed service without first obtaining the empty display buffer from the management component 146. In a scenario in which the display sharing application 161 is executed in a display sharing system 106, the management component 148, the operating system 140, or another component installed on the client device 109, such as a browser plug-in, can stream the empty display buffer to the display sharing application 161. Thereafter, the process shown in FIG. 6 proceeds to completion

If, at step 609, the currently foregrounded application 149 is a whitelisted application, the process can proceed to step 617. At step 617, the client device 109 can identify the region of the fore rounded application 149 that should be obscured or hidden. The region can be identified by the application 149 and coordinates provided to the management component 148 or display sharing application 151. The coordinates can specify a two-dimensional region within the display buffer that should be obscured or hidden when the operating system display buffer is provided to the display sharing application 151.

At step 619, the client device 109 can initiate streaming of the operating system display buffer to the display sharing application 151 executed on the client device 109 or the display sharing application 161 executed on a display sharing system 106. The client device 109 can obscure or hide the region identified by the application 149 at step 617. The client device 109 can initiate streaming of the operating display buffer through the management component 148 or through the display sharing application 151. In one example, the management component 148 can obscure or hide the specified region and then stream the operating system display buffer to the display sharing application 151, which can in turn stream the operating system display buffer to the management service 112 or another remotely executed service. In another example, the display sharing application 151 executing on the client device 109 can obscure or hide the specified region and then stream the operating system display buffer to a remotely executed service without first of the operating system display buffer from the management component 148. In a scenario in which the display sharing application 161 is executed in a display sharing system 106, the management component 148, the operating system 140, or another component installed on the client device 109, such as a browser plug-in, can stream the operating system display buffer to the display sharing application 161. Thereafter, the process shown in FIG. 5 proceeds to completion.

The client devices 109 or devices comprising the management system 103 can include at least one processor circuit, for example, having a processor and at least one memory device, both of which couple to a local interface, respectively. The client device 109 can include, for example, at least one computer, a mobile device, smartphone, computing device, or like device. The local interface can include, for example, a data bus with an accompanying address/control bus or other bus structure. Stored in the memory device are both data and several components that are executable by the processor. In particular, stored in the one or more memory devices and executable by the device processor can be the application 149, and potentially other applications. Also stored in the memory can be a data store 115 and other data.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, men my card, optical disc such as compact disc (CD) or digital versatile disc (DVD), floppy disk, magnetic tape, or other memory components.

Memory can lade both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the management service 112, the management component 148, display sharing application 151 and other various systems described herein cat be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagram and flowcharts show an example of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram and flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including instructions and declarations that, can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof For example, a plurality of the applications described herein can execute in the same computing device, or in multiple computing devices.

It is emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure.

What is claimed is:

1. A method, comprising:
identifying, ley a management component executed by a client device, a display sharing profile, the display sharing profile identifying at least one application authorized to share user interface activity with a display sharing application;
causing by the management component, the display sharing profile to be installed on the client device, wherein the display sharing profile is accessible to the Management component;
identifying, by the management component, a request to initiate a display sharing session with the display sharing application;
identifying, by the management component, a foregrounded application executing on the client device;
determining, by the management component, that the display sharing profile authorizes the foregrounded application to share user interface activity with the display sharing application; and
causing an operating system screen buffer to be streamed to the display sharing application.

2. The method of claim 1, wherein the display sharing application executed on the client deice is configured to cause the operating system screen buffer to be accessible to a remotely executed service.

3. The method of claim 1, wherein the display sharing application is executed remotely from the client device, and wherein the display sharing application obtains the operating system screen buffer from the client device over a network.

4. The method of claim 1, wherein the operating system screen buffer is obtained by the management component, and wherein the management component forwards the operating system screen buffer to the display sharing application over the network.

5. The method of claim 1, further comprising:
detecting, by the management component, that a second application is foregrounded on the client device;
determining, by the management component, that the second application is not identified by the display sharing profile; and
causing the streaming of the operating system screen buffer to the display sharing application to be terminated.

6. The method of claim 1, wherein the display sharing profile identifies the at least one application based at least in part on a bundle identifier, wherein the bundle identifier uniquely identities the at least one application.

7. The method of claim 1, further comprising:
obtaining, from the foregrounded application, a specification of a region of the operating system screen buffer that should be obscured from the display sharing application; and
causing the region of the operating system screen buffer to be obscured from the display sharing, application.

8. A system, comprising:
a client device; and
at least one application executed on the client device, the at least one application being configured to cause the client device to at least:
obtain a display sharing profile, the display sharing profile identifying at least one application authorized to share user interface activity with a display sharing application;
cause the display sharing profile to be installed on the client device, wherein the display sharing profile is accessible to the management component;
identify a request to initiate a display sharing session with the display sharing application;
identify a foregrounded application executing on the client device;
determine that the display sharing profile authorizes the foregrounded application to share user interface activity with the display sharing application; and
cause an operating system screen buffer to be streamed to the display sharing application.

9. The system of claim 8, wherein the display sharing application executed on the client device is configured to cause the operating system screen buffer to be accessible to a remotely executed service.

10. The system of claim 8, wherein the display sharing application is executed remotely from the client device, and wherein the display sharing application obtains the operating system screen buffer from the client device over a network.

11. The system of claim 8, wherein the operating system screen buffer is obtained by the management component, and wherein the management component forwards the operating system screen buffer to the display sharing application over the network.

12. The system of claim 8, wherein the at least one application is further configured to at least:
detect that a second application is foregrounded on the client device;
determine that the second application is not identified by the display sharing profile; and
cause the streaming of the operating system screen buffer to the display sharing application to be terminated.

13. The system of claim 8, wherein the display sharing profile identifies the at least one application based at least in part on a bundle identifier, wherein the bundle identifier uniquely identifies the at least one application.

14. The system of claim 8, wherein the at least one application is further configured to at least:
obtain a specification of a region of the operating system screen buffer that should be obscured from the display sharing application; and
cause the region of the operating system screen buffer to be obscured from the display sharing application.

15. A non-transitory computer-readable medium embodying executable instructions, which, when executed by at least one processor of a client device, causes the client device to at least:
identify a display sharing profile, the display sharing profile identifying at least one application authorized to share, user interface activity with a display sharing application;
cause the display sharing profile to be installed on the client device;
identify a request to initiate a display sharing session with the display sharing application;
identify a fore grounded application executing on the client device;
determine that the display sharing profile authorizes the foregrounded application to share user interface activity with the display sharing application; and
cause an operating system screen buffer to be streamed to the display sharing application.

16. The non-transitory computer-readable medium of claim 15, wherein the display sharing application executed on the client device is configured to provide the operating system screen buffer to a remotely executed service.

17. The non-transitory computer-readable medium of claim 15, wherein the display sharing application is executed remotely from the client device, and wherein the display sharing application obtains the operating system screen buffer from the client device over a network.

18. The non-transitory computer-readable medium of claim 15, wherein the operating system screen buffer is obtained by a management component executed by the client device, and wherein the management component causes the operating system screen buffer to be forwarded to display sharing application the network.

19. The non-transitory computer-readable medium of claim 15, wherein the client device is further configured to at least:
detect that a second application is foregrounded on the client device;
determine that the other application is not identified by the display sharing profile; and
cause the streaming of the operating system screen buffer to the display sharing application to be terminated.

20. The non-transitory computer-readable medium of claim 15, wherein the client device is further configured to at least:
obtain a specification of a region of the operating system screen buffer that should be obscured from the display sharing application; and
cause the region of the operating system screen buffer to be obscured from the display sharing application.
